(19) United States
(12) Patent Application Publication
(10) Pub. No.: US 2007/0136557 A1
(43) Pub. Date: Jun. 14, 2007

(54) Information processing apparatus for translating IP address and program therefor

(76) Inventors: Kazuya Okochi, Tokyo (JP); Toyohisa Morita, Tokyo (JP); Hirofumi Nakakoji, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/589,851

(22) Filed: Oct. 31, 2006

(30) Foreign Application Priority Data
Dec. 9, 2005 (JP) 2005-356190

(51) Int. Cl. G06F 12/00

(52) U.S. Cl. 711/209

(57) ABSTRACT

A storage unit 104 of an address management apparatus 100 stores translation information 104C that associates, one-to-one, a value that can be taken by data in a block of a translation object address, with its post-translation value. An address translation unit 1032 reads, from the translation information 104C, a post-translation value associated with a value indicated by data of each block defined in the translation object IP address. Data of each block of the translation object address is translated based on the read post-translation value. This improves security in cases where access log data is provided to a third party.

### INCORPORATION BY REFERENCE

This application claims priority based on a Japanese patent application, No. 2005-356190 filed on Dec. 9, 2005, the entire contents of which are incorporated herein by reference.

### BACKGROUND OF THE INVENTION

The present invention relates to a technique of managing access log data collected by a system on a network, and particularly to information processing performed to translate an IP address of an access source machine (i.e. a machine from which access has occurred), which is included in access log data.

To cope with computer viruses, access log data remaining in a router or a fire wall are analyzed. For example, “Distributed Intrusion Detection System”, <URL: http://www.dShield.org/> describes a distributed intrusion detection system that collects and analyzes access log data from a plurality of observation points, such as a fire wall or the like, on the Internet. When the access log data is collected in this system, processing such as conversion, encrypting, or the like, is not implemented on IP addresses included in the log data, and a method is adopted in which log data is transmitted to an analysis system from the observation points. This is clear from the fact that the abovementioned system has a specification in which, when collecting access log data, a form is used in which data that is not encrypted by a web browser is transmitted.

### SUMMARY OF THE INVENTION

Generally, many access events to an access log data collection machine come from machines on the same sub-network to which the access log data collection machine belongs. Thus, when masses of log data are collected, there is a possibility that the sub-network on which the access log data collection machine exists is inferred from those access log data. Preferably, such information should be concealed from the viewpoint of security improvement. For example, when a machine is infected with a computer virus or a worm, it is possible that a machine close to the infected machine in a network will be infected with that virus or worm too. Accordingly, it is not favorable that the sub-network on which the access log data collection machine exists is conjectured by a third party.

The present invention improves security in cases where access log data are provided to a third party. More specifically, the present invention provides a system that safely performs analysis of access log data of an observation point, without information such as an IP address of the observation point being made known to a third party.

In detail, according to one mode of the present invention, an information processing apparatus that translates an IP address into an address whose value is different from a value of the IP address, comprises: a storage means, which stores translation information that associates, one-to-one, a first value indicated by data within a domain of data of a predetermined number of bits, with a second value; and a processing means, which reads from the translation information the second value associated with the first value corresponding to a value indicated by data in a block and translates the data in the block based on the read second value, for each block that is defined in the IP address and that includes data of a value indicated by data of the predetermined number of bits.

In accordance with the abovementioned mode, it is possible to safely provide a system that performs analysis of access log data of an observation point, without information such as an IP address being made known to a third party.

According to the present invention, it is possible to improve security in cases where access log data are provided to a third party.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a schematic diagram exemplifying a hardware configuration of an information processing apparatus according to an embodiment of the present invention;

FIG. 2 is a flowchart exemplifying public log data generation processing according to an embodiment of the present invention;

FIG. 3 is diagram exemplifying data description of a log file before translation in FIG. 1;

FIG. 4 is a diagram exemplifying layout of a division information setting screen according to an embodiment of the present invention;

FIG. 5 is a diagram exemplifying data included in the division information in FIG. 1;

FIG. 6 is a diagram conceptually showing a data structure of the translation information in FIG. 1;

FIG. 7 is a diagram exemplifying data description of a log file after the translation in FIG. 1;

FIG. 8 is a diagram exemplifying a configuration of a network system including an address management apparatus according to an embodiment of the present invention and an analysis apparatus that receives output of the address management apparatus;

FIG. 9 is a flowchart exemplifying a log data analysis service provided to a user of the address management apparatus according to the embodiment in the system of FIG. 8;

FIG. 10 is a diagram exemplifying a configuration of a network system according to an embodiment of the present invention, including a plurality of address management apparatuses and an analysis apparatus that receives output of those address management apparatuses;

FIG. 11 is a diagram exemplifying a configuration of another analysis apparatus according to an embodiment of the present invention; and

FIG. 12 is a flowchart exemplifying a log data analysis service provided to a user of an address management apparatus according to the embodiment in the system of FIG. 11.

### DETAILED DESCRIPTION OF THE EMBODIMENTS

Now, referring to the attached drawings, an embodiment according to the present invention will be described.

First, a configuration of an information processing apparatus (hereinafter, referred to as an address management apparatus) of the present embodiment will be described.

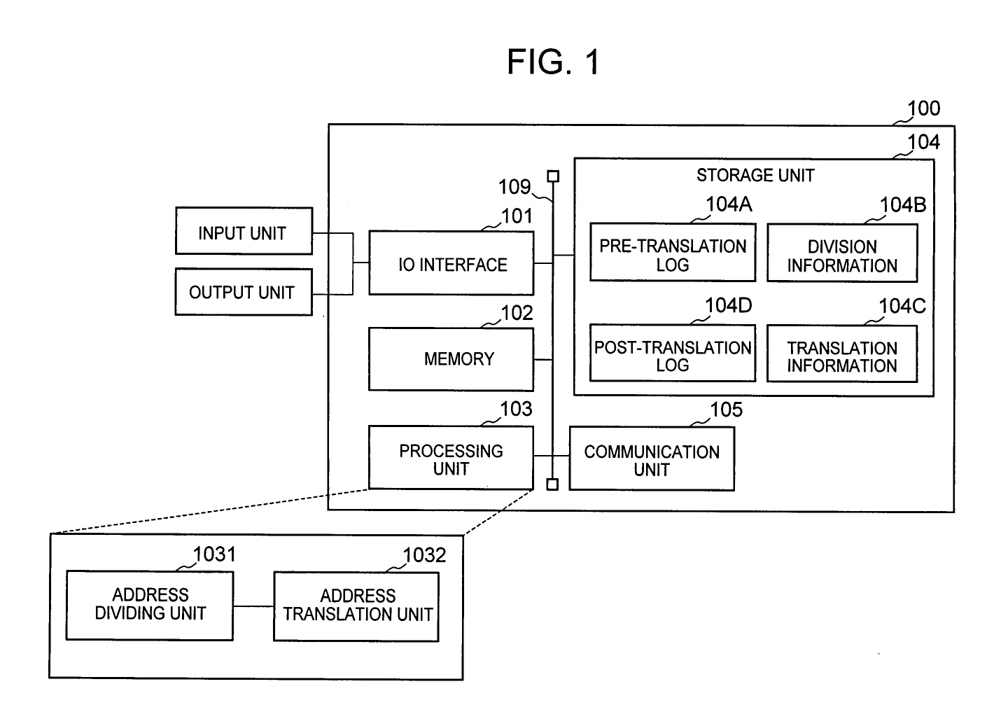

As shown in FIG. 1, the address management apparatus 100 of the present embodiment comprises: an input-output interface 101 for connecting an input unit and an output unit; a memory 102; a storage unit 104 that stores various programs and the like; a processing unit 103 for executing a program loaded from the storage unit 104 into the memory 102; a drive (not shown) that controls data read from a storage medium and the like; a communication unit 105 for controlling communication through a network; an internal signal line 109 such as a bus connecting these component units; and the like.

The storage unit 104 stores an address management program (not shown) that defines the below-described address management processing. The address management program may be installed onto the storage unit 104, for example, from a storage medium through the drive or through a network.

Further, in addition to the address management program, the storage unit 104 stores the following pieces of information 104A-104D that the address management program refers to.

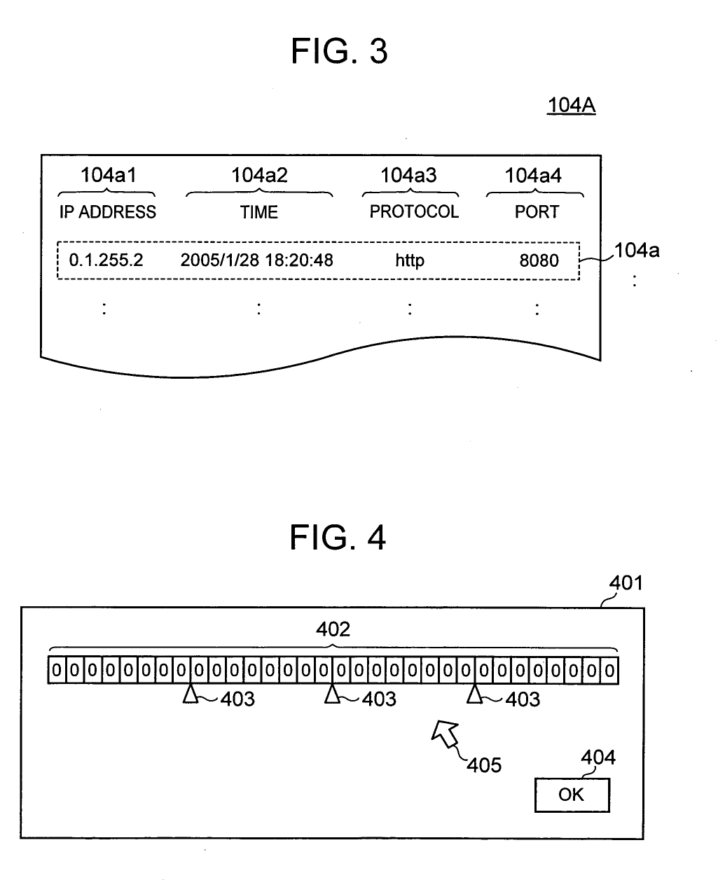

As shown in FIG. 3, an access log file (a pre-translation log file) 104A describes access log data 104a collected by an access log collection machine (such as a router, a fire wall, an intrusion detection system (IDS), a gateway, a server or the like). Each piece of access log data includes an IP address 104a1 of an access source machine, an access time 104a2, a used protocol 104a3, a port number 104a4 of a port that has received the access, and the like. An IP address in each piece of access log data is a translation object address in the below-described address management processing.

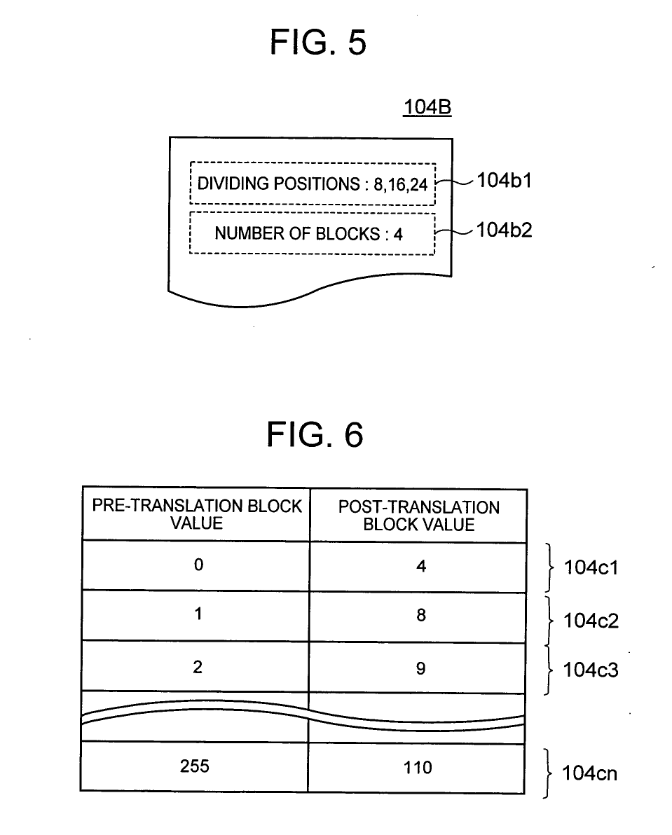

As shown in FIG. 5, division information 104B includes the number of blocks 104b2 included in a translation object address and dividing position information 104b1 indicating boundary positions between blocks of the translation object address. Stored here, as the dividing position information 104b1, are boundary position offset values from the first bit (each offset value is the number of bits from the first bit of a translation object address in decimal notation to the last bit of the block concerned). For example, FIG. 5 shows division information in cases where a translation object address in decimal notation is divided at three boundary positions (8th bit, 16th bit, and 24th bit) into four 8-bit blocks.

As shown in FIG. 6, translation information 104C stores correspondence information 104c1-104cn that associates a value (a pre-translation block value) allowable for data in a block of a translation object address with its value after translation (a post-translation block value). In other words, the translation information 104C is a table that associates a pre-translation block value with a post-translation block value, one-to-one. When data of each block in a translation object address is translated according to the translation information 104C, the translation object address is translated into an address consisting of blocks indicating different values from the original blocks.

Shown here is translation information 104C that is commonly used for translating all the blocks of a translation object address. However, it is possible to prepare different translation information for each block of a translation object address.

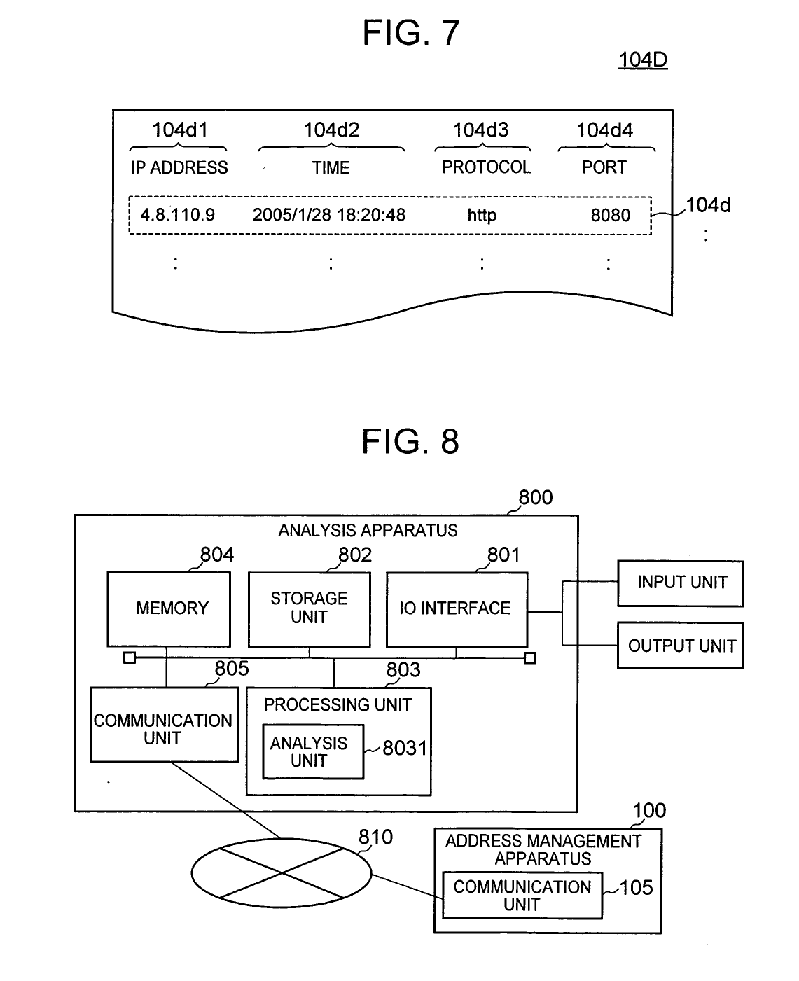

As shown in FIG. 7, a public access log file (a post-translation log file) 104D stores public log data 104d obtained from each piece of access log data 104a of a pre-translation log file 104A. Each piece of public log data 104dincludes: a public address 104d1 obtained by translation of each block of a translation object address in the corresponding access log data; and the same data 104d2-104d4 as the data (the access time 104a2, the used protocol 104a3, and the port number 104a4) in the corresponding access log data. The public log data are generated by the below-described address management processing.

The processing unit 103 executes the address management program to realize functional components, i.e. an address dividing unit 1031 for generating the division information 104B and an address translation unit 1032 for translating each block of a translation object address according to the division information 104B and the translation information 104C.

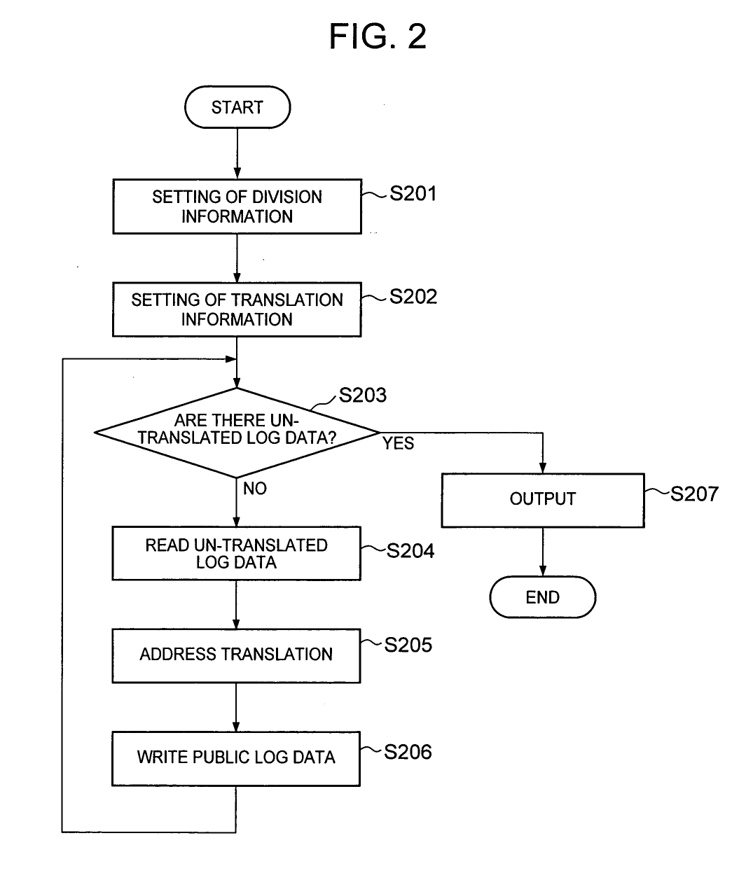

Public log data generation processing is realized through functions of these functional components. Referring to FIG. 2, the public log data generation processing will now be described. Here, it is assumed that a pre-translation log file 104A (which describes access log data 104a including 32-bit IPv4 addresses) is read by the storage unit 104 before starting the below-described processing.

In response to a predetermined command inputted by a user through the input unit, the address dividing unit 1031 refers to the division information 104B in the storage unit 104, generates a division information setting screen based on the division information 104B, and displays the generated screen on the output unit.

In this division information setting screen are arranged a series of boxes corresponding to a bit string of a translation object address and an OK button for receiving a setting completion instruction. Since the translation object address is a 32-bit IPv4 address, the division information setting screen 401 shows a series of 32 boxes 402 and the OK button 404, as shown in FIG. 4. Although a translation object address is a 32-bit IPv4 address in the present embodiment, the number of boxes in the division information setting screen will be 128 in cases where a translation object address is a 128-bit IPv6 address.

When the user designates a location between two adjacent boxes using a mouse cursor 405 through the input unit, a slider 403 indicating a boundary position between blocks is located at the designated position. Thus, the user can set a boundary position between blocks in the translation object address.

Then, when the user pushes the OK button 404, the address dividing unit 1031 generates division information 104B based on the content set in the division information setting screen, and stores the division information 104B into the storage unit 104 (S201). The division information 104B generated here stores a numerical value obtained by adding one to the number of sliders 403 in the division information setting screen as block number of blocks 104b2. Further, the division information 104B stores the number of blocks from the first box in the box string 402 up to each of the sliders 403, as the dividing position information 104b1.

Then, the user generates a table that associates a block value with a block value after translation, one-to-one, using the input unit, and stores the generated table as the translation information 104C into the storage unit 104 (S202). Although here the user inputs the translation information, the address management apparatus 100 may automatically generate the translation information. For example, the address translation unit 1032 may automatically generate the translation information by associating, one-to-one, each value (a pre-translation block value) that a block of a size determined from the dividing position information 104b1 can take with a random number (a post-translation block value) generated using time, or the like, as a seed. In such a case, external input of the translation information is not necessary. Further, since external input of the translation information is not necessary, it is possible to improve secrecy of the translation information.

When the division information 104B and the translation information 104C have been prepared as described above, the address dividing unit 1031 sends a notice to that effect to the address translation unit 1032. In response to this, the following processes (S203-S209) are started.

The address translation unit 1032 refers to the translation object log file 104A in order to check whether all piece access log data in the pre-translation log file 104A have been translated (S203).

In cases where all pieces of access log data in the pre-translation log file 104A have been translated, the address translation unit 1032 reads all pieces of public log data in the post-translation log file 104D from the storage unit 104, and outputs them to an external system through, for example, the communication unit 105 (S207).

On the other hand, in cases where un-translated access log data remains in the pre-translation log file 104A, the address translation unit 1032 reads, as a translation object log data, one un-translated record of access log data from the translation object log file 104A, and reads, as a translation object address, the IP address 104al included in this translation object log data (S204).

Then, the address translation unit 1032 translates the translation object address into a public address based on the division information 104B and the translation information 104C in the storage unit 104, to generate public log data corresponding to the translation object log data (S205). Details will be described in the following.

The address translation unit 1032 reads the translation information 104C from the storage unit 104, and converts a pre-translation block value and a post-translation block value in each piece of correspondence information and the translation object address into binary notation expressions.

Then, the address translation unit 1032 reads the division information 104B from the storage unit 104, and cuts out blocks from the translation object address in binary notation with respect to boundaries indicated by the dividing position information 104b1 in the division information 104B. For example, in cases where the dividing position information 104b1 in the division information 104B shows three boundary positions (8th bit, 16th bit and 24th bit) at 8-bit intervals, the address translation unit 1032 extracts a first block ranging from the 1st bit to the 8th bit of the address, a second block ranging from the 9th bit to the 16th bit, a third block ranging from the 17th bit to the 24th bit, and a fourth block ranging from the 25th bit to the end bit. In cases where the dividing position information 104b1 in the division information 104B shows only one boundary position (16th bit), the address translation unit 1032 extracts a first block ranging from the 1st bit to the 16th bit of the address and a second block ranging from the 17th bit to the end bit of the address.

The address translation unit 1032 searches the translation information 104C for a pre-translation block value (i.e. a value before translation into a binary notation) corresponding to a block value of each extracted block, and reads a post-translation block value expressed in binary notation associated with the retrieved pre-translation block value. Further, the address translation unit 1032 concatenates the obtained post-translation block values in binary notation in order of the corresponding blocks in the translation object address. As a result, a public address in binary notation is generated.

For example, in the case where two blocks each of 16 bits are extracted from the translation object address in binary notation, in the first place respective block values of the first block of the upper 16 bits and the second block of the lower 16 bits are translated according to the translation information in binary notation (a table that associates, one-to-one, pre-translation block values in binary notation corresponding to 0-65535 with respective post-translation block values in binary notation). Then, the post-translation block values in binary notation are concatenated to obtain a public address in binary notation.

Then, the address translation unit 1032 translates each 8 bits of the public address in binary notation into a decimal notation from the top of the address, and inserts a period between adjacent blocks in decimal notation to punctuate the translated address. In the present embodiment, the obtained address in decimal notation is used as a public address. However, four figures of the address in decimal notation (i.e. four figures divided with periods) may be subjected to a predetermined operation to be converted into figures within a value range in which a figure of an ordinary IP address cannot come, and an address consisting of the resultant figures may be used as a public address. Usually, an IP address in decimal notation consists of four figures each being in a value range 0-255. Thus, for example, it is possible to add 256 to each of the four figures of the above-obtained address in decimal notation in order to obtain a public address to use. As a result, the obtained public address consists of four figures each of which cannot be used as a component figure of an IP address. Accordingly, a public address and an actual IP address can be easily distinguished from each other, and confusion between a public address and an actual IP address can be prevented. Further, a user who deals with a public address can recognize that the public address is not a true IP address, and thus can feel safe.

Once the address translation unit 1032 obtains the public address, the address translation unit 1032 takes out data 104a2-104a4, which is outside of the IP address 104a1, from the access log data read in S204, and generates public log data including these data and the public address in decimal notation.

Then, the address translation unit 1032 writes the public log data generated by the above-described address translation processing (S205), as an additional record 104d to the post-translation log file 104D in the storage unit 104 (S206). Then, the address translation unit 1032 returns to the processing of S203.

According to the above-described public log data generation processing, an IP address of an access source machine is translated into a value and then stored in the public log data. Accordingly, even if the public log data are disclosed to a third party, the third party's specifying the actual IP address of the access source machine is prevented. Thus, it is possible to prevent leakage of information related to a sub-network on which an access log data collection machine exists. In other words, it is possible to improve security in cases where log data are provided to a third party.

Further, since it is possible to prevent a third party (which has received log data) from specifying an access source machine, private information indicating, for example, which user has accessed each site can be kept secret. In other words, privacy protection of a user of an access source machine can be reinforced.

Thus, since disclosure of log data to a third party becomes less disadvantageous, it is possible to promote use of a valuable service provided by a third party even if the service requires provision of log data. Next, this type of service will be described. Here, a log data analysis service provided to a user of the address management apparatus 100 will be taken as an example.

As shown in FIG. 8, a network 810 connects the address management apparatus 100 with an analysis apparatus 800 to which the address management apparatus 100 outputs public log data.

The analysis apparatus 800 comprises: an input-output interface 801 connected with an input unit and an output unit; a communication unit 805 for controlling communication through the network 810; a storage unit 802 in which programs are installed; a memory 804; a processing unit 803 for executing an analysis program loaded from the storage unit 802 onto the memory 804; and an internal signal line such as a bus connecting the mentioned components.

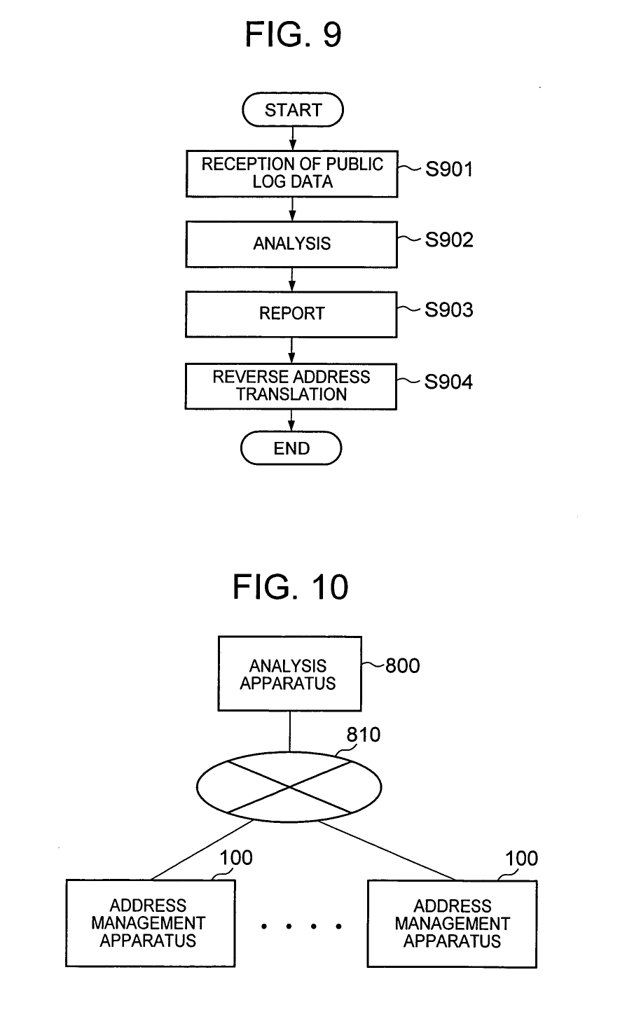

The processing unit 803 executes the analysis program to realize an analysis unit 8031 that performs log data analysis processing. According to functions of this analysis unit 8031, log data analysis service is provided to the user of the address management apparatus according to the flowchart shown in FIG. 9.

When the communication unit 805 receives public log data outputted by the address management apparatus 100 in S207, the analysis unit 8031 stores the received public log data into the storage unit 802 (S901).

Then, based on the public log data in the storage unit 802, the analysis unit 8031 performs ordinary analysis processing (aggregation, statistics and the like) (S902). Thus, for example, the analysis unit 8031 extracts public log data indicating a possibility of illegal access, from public log data.

Further, the analysis unit 8031 reads a public address 104d1 from the extracted public log data and returns a report message including the public address, to the address management apparatus 100, through the communication unit 805 (S903). At this time, furthermore, the analysis unit 8031 may disclose information (such as a time zone in which many access events arise, or a port number that has received many access events) that can be shown to the public even if IP addresses are kept secret.

With regard to the address management apparatus 100, when the communication unit 105 receives the report message from the analysis apparatus 800, the address translation unit 1032 extracts the public address from the report message and restores the actual IP address of the access source machine from the extracted public address, based on the division information 104B and the translation information 104C in binary notation (S904). In detail, the following reverse address translation processing is performed.

The address translation unit 1032 converts the public address into binary notation, and extracts blocks from the public address in binary notation based on the dividing position information 104d2 of the division information 104D. Then, the address translation unit 1032 searches the translation information 104C in binary notation for post-translation block values coincident with respective block values. The address translation unit 1032 extracts pre-translation block values corresponding respectively to the obtained post-translation block values from the translation information 104C. Further, the address translation unit 1032 concatenates the obtained pre-translation block values in order of the corresponding blocks in the post-translation address. As a result, the IP address in binary notation of the access source machine is obtained. Then, each 8 bits of the IP address in binary notation is translated into a decimal notation from the top of the IP address. Thus, the address management apparatus 100 can specify the IP address of the machine from which illegal access may have occurred.

Thus, it is possible to entrust analysis of log data (for example, for specifying a machine that is suspected of illegal access) to an external system while concealing the true IP address of the access source machine. It is difficult to specify an actual IP address of the access source machine based on a post-translation address. Accordingly, even if masses of log data are provided to an external system, it is difficult for the external system to estimate information on a sub-network on which the access log data collection machine exists. Further, since it is difficult to specify an access source machine based on a post-translation address, leakage of information on a user of the access source machine to an external system can be prevented.

Thus, it is possible to use an external service such as a contract analysis service while intending to maintain security and protect the privacy of a user of an access source machine.

FIG. 8 exemplifies cases where one address management apparatus provides public log data to one analysis apparatus 800. Of course, as shown in FIG. 10, a plurality of address management apparatuses 100 may exist on a network 810 and supply public log data to one analysis apparatus 800. In that case, when the analysis apparatus 800 receives public log data from some address management apparatus, it is sufficient that the analysis apparatus perform the above processing (S902-S903 in FIG. 9) and return the obtained report message to the sender of the public log data. Thus, a plurality of address management apparatuses can share one analysis apparatus 800.

In the above, the user sets all the boundary positions in a translation object address. However, a part or all of boundary positions may be set automatically. For example, the address management apparatus 100 may obtain a sub-net mask from the operating system of the access log data collection machine, and may set a boundary position, which is obtained from the sub-net mask, between a network address part (upper bits) of an IP address and a host address part (lower bits), as a boundary position between blocks. Further, in addition to the boundary position between the network address part and the host ID part, positions designated by the user may be set as boundary positions between blocks.

As a result, post-translation IP addresses of all machines belonging to the same sub-net to which the access log data collection machine belongs have a common data value for upper bits that correspond to the network address part. In other words, with respect to a machine existing on the same sub-net on which the access log data collection machine exists, the IP address of that machine is translated into an address that is shown as being located near the access log data collection machine.

Accordingly, it is possible to judge whether a post-translation public address is an address of a machine belonging to the same sub-net to which the access log data collection machine belongs (i.e. a machine near to the access log data collection machine) or an address of a machine belonging to an external network. Thus, when it is found that data are infected with a virus, a worm or the like, it is possible to judge from the post-translation public address whether the data infected with the virus or worm are data within the intranet or are data received from a machine on an external network.

In the above description, a pre-translation log file 104A is read before starting the public log data generation processing, and public log data are generated from all log data 104a described in the pre-translation log file 104A. However, it is possible to generate public log data from new access log data each time an access event occurs. In other words, it is not necessary to translate IP addresses of mass access log data into public addresses all at once and off-line. It is possible that each time the access log data collection machine generates new access log data, the address management apparatus 100 translates the IP address of the new access log data into a public address on a real-time basis.

To this end, differently from the above-described case (see FIG. 2), it is sufficient that, when the communication unit 105 receives an access log record from the access log data collection machine on the network, the address translation unit 1032 performs the above-described address translation processing (similar to S205) with respect to this access log data as translation object log data, and outputs the resultant public log data to the external system through the communication unit 105.

As a result, each time an access event occurs in the access log data collection machine, the external system can receive public log data on a real-time basis. Thus, as soon as an access event occurs in the access log data collection machine, the external system in the subsequent stage can take action relating to the access event (for example, analytic processing such as statistical processing of the log data).

In the above description, the address management apparatus 100 does not provide the translation information 104C to the outside. However, the address management apparatus 100 may provide the translation information 104C to the party to which the log data is supplied. This will be described taking an example of where the log data is supplied to an analysis apparatus.

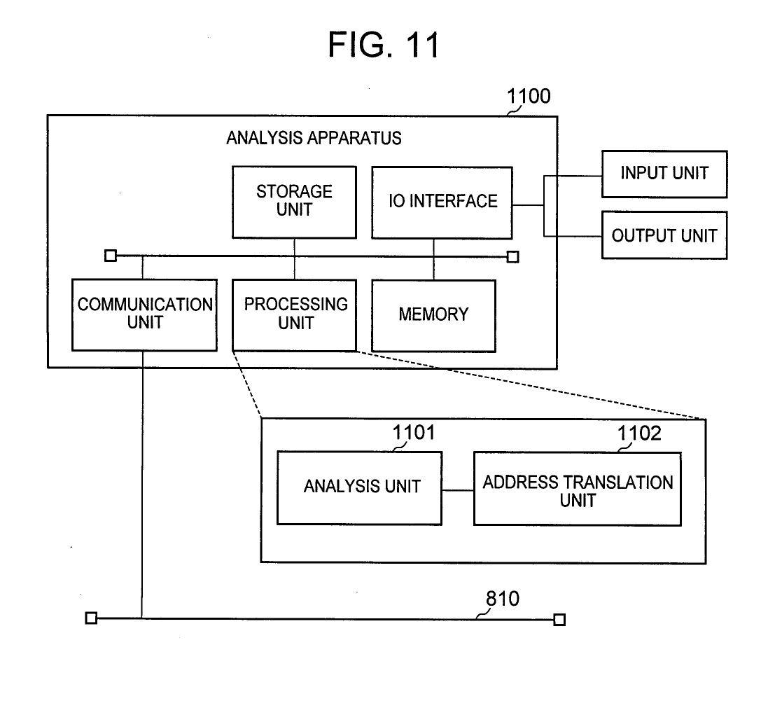

As shown in FIG. 11, an analysis apparatus 1100 in this case has a hardware configuration similar to that of the above-described analysis apparatus 800. However, a functional configuration realized when the processing unit executes an analysis program is different from that of the above-described analysis apparatus 800. That is to say, in the analysis apparatus 1100 in this case, the analysis program realizes an address translation unit 1102 in addition to an analysis unit 1101.

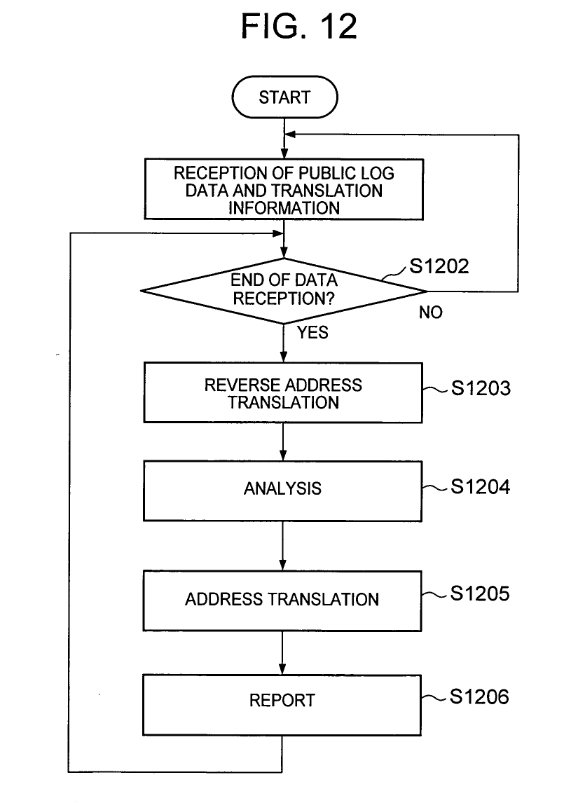

FIG. 12 exemplifies a flowchart of analysis processing realized by the above-mentioned functional configuration. Here, a description will be given taking the example of where a plurality of address management apparatuses provide public log data and the like, to the analysis apparatus.

In this case, in S207, each address management apparatus 100 outputs the translation information 104C in binary notation in addition to the public log data, to the analysis apparatus 1100. With regard to the analysis apparatus 1100, when the communication unit receives public log data and translation information 104C from some address management apparatus, the analysis unit 1101 stores the public log data and the translation information 104C in the storage unit (S1201). Here, the public log data and the translation information are stored in a file having a file name from which it is possible to recognize which address management apparatus has sent the data.

The analysis unit 1101 judges whether public log data and the like have been received from all the address management apparatuses (S1202). In cases where public log data and the like have not been received from some address management apparatus, the analysis unit 1101 waits for input of public log data and the like, from that address management apparatus (S1201).

On the other hand, in cases where public log data and the like have been received from all the address management apparatuses, then for each address management apparatus, the address translation unit 1102 reads a public address and the translation information in the public log data from the storage unit. According to processing similar to the above-described reverse address translation processing (S904 in FIG. 9), the address translation unit 1102 translates the public address into a true IP address based on the translation information (S1203). Then, the address translation unit 1102 overwrites the public address in the public log data in the storage unit with the true IP address.

The analysis unit 1101 merges all pieces of public log data of all the address management apparatuses, and performs ordinary analysis processing (S1204). As a result, public log data indicating a possibility of illegal access can be extracted from public log data of a plurality of sites, and the access source machine concerned can be specified by its actual IP address.

When an IP address of a machine as a source of illegal access is known as a result of the analysis, the address translation unit 1102 reads all translation information associated with public log data including that IP address, and uses each piece of translation information to perform processing similar to the above-described address translation processing (S205 in FIG. 2). As a result, the IP address of the machine as the source of illegal access is translated into a public address for each sender (i.e. an address management apparatus) of the corresponding public log data (S1205). Then, the analysis unit 1101 returns a report message, which includes the public address obtained at this time, to the sender of the corresponding public log data through the communication unit (S1206).

According to the above-described analysis processing, it is possible to specify a suspicious access source machine, based on masses of log data collected at a plurality of sites. Thus, with each address management apparatus, it is possible to recognize an access source machine that is judged to be suspicious as a result of comprehensive analysis considering log data of not only its own site but also other sites. In other words, it is possible to recognize an access source machine that is considered to be suspicious according to more reliable judgment.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. An information processing apparatus that translates an IP address into an address whose value is different from a value of the IP address, the apparatus comprising:
a storage means, which stores translation information that associates, one-to-one, a first value indicated by data within a domain of data of a predetermined number of bits, with a second value; and
a processing means, which reads from the translation information the second value associated with the first value corresponding to a value indicated by data in a block and translates the data in the block based on the read second value, for every block that is defined in the IP address and that includes data of a value indicated by data of the predetermined number of bits.

2. An information processing apparatus according to claim 1, wherein:
the processing means reads, as the IP address that is an object of translation, an access source machine's IP address included in access log data, and outputs the access log data that includes the IP address after the translation instead of the access source machine's IP address.

3. An information processing apparatus according to claim 2, wherein:
the processing means sets, as a boundary of the block, a position corresponding to a boundary between a network address part and a host address part of an IP address of a machine that collects the access log data.

4. An information processing apparatus according to claim 1, wherein:
the processing means translates data in each block into data of a third value that is outside the domain and has a predetermined relationship with the second value read relating to the block concerned.

5. An information processing apparatus according to claim 1, further comprising an input receiving means that receives a designation of a boundary position of the block; wherein
the processing means sets the block in the IP address with a designated boundary position as a boundary.

6. A program product that makes an information processing apparatus, comprising a storage means and a processing means, execute translation processing of an IP address, wherein:
the program product includes a medium that can be used by the information processing apparatus; and
the medium includes program code that embodies:
a first process, in which the storage means is made to store translation information that associates a first value indicated by data within a domain of data of a predetermined number of bits, with a second value;
a second process, in which the processing means is made to read, from the translation information stored in the storage means, the second value associated with the first value corresponding to a value indicated by data in a block, for each block that is defined in the IP address and that includes data of a value indicated by data of the predetermined number of bits; and
a third process, in which the processing means is made to translate the data in each block, based on the second value that has been read with respect to the block concerned.

7. A program product according to claim 6, wherein:
the medium includes the program code that further embodies:
a fourth process, in which the processing means is made to read, as the IP address that is an object of translation, an access source machine's IP address, included in access log data; and
a fifth process, in which the processing means is made to output the access log data that includes the IP address after the translation by the second process, instead of the access source machine's IP process.

8. A program product according to claim 7, wherein:
in the second process, the program code makes the processing unit set, as a boundary of the block, a position corresponding to a boundary between a network address part and a host address part of an IP address of a machine that collects the access log data.

9. A program product according to claim 6, wherein:
in the third process, the program code makes the processing unit translate data in each block into data of a third value that is outside the domain and has a predetermined relationship with the second value read relating to the block concerned.

10. A program product according to claim 8, wherein:
the information processing apparatus further comprises an input receiving means;
the medium includes the program code that further embodies a sixth process, in which the input receiving means is made to receive a designation of a boundary position of the block; and
in the first process, the program code makes the processing unit set the block in the IP address, based on the boundary position whose designation has been received by the input receiving means.
